(19) United States
(12) Patent Application Publication
(10) Pub. No.: US 2015/0374024 A1
(43) Pub. Date: Dec. 31, 2015

(54) MICROBIAL REDUCTION IN NUTRITIONAL PRODUCT USING AN EXTRUSION PROCESS

(71) Applicant: ABBOTT LABORATORIES, Abbott Park, IL (US)

(72) Inventors: Douglas Wearly, Blacklick, OH (US); Eik-Lang Lau, Buffalo Grove, IL (US); Terrence Mazer, New Albany, OH (US); Normanella Dewille, Columbus, OH (US); Gary Katz, Columbus, OH (US); Wendy Fox, Hilliard, OH (US)

(73) Assignee: ABBOTT LABORATORIES, Abbott Park, IL (US)

(21) Appl. No.: 14/770,876

(22) PCT Filed: Mar. 12, 2014
(86) PCT No.: PCT/US2014/023919

§ 371 Date: Aug. 27, 2015

Related U.S. Application Data
(60) Provisional application No. 61/776,961, filed on Mar. 12, 2013.

(51) Int. Cl. A23L 3/18; A23L 3/015; A23P 1/12; A23L 3/3571

(52) U.S. Cl. CPC A23L 3/18; A23L 3/3571; A23L 3/015; A23P 1/12; A23V 2002/00

(57) ABSTRACT

A method of reducing a pathogenic microorganism population in a powdered nutritional food composition is described herein. The powdered nutritional food composition includes a fat, a protein, and a carbohydrate. The method includes forming an emulsion of the powdered nutritional food composition and extruding the emulsified powdered nutritional food composition at a temperature of less than about 100° C. The method produces at least a 5 log reduction in the pathogenic microorganism population in the extruded powdered nutritional food composition. The extruded powdered nutritional food composition has a water activity level of about 0.3 to about 0.95.

### CROSS-REFERENCE TO RELATED APPLICATIONS

This application claims priority to and any benefit of U.S. Provisional Application No. 61/776,961, filed Mar. 12, 2013, the entire contents of which are incorporated by reference in its entirety.

### FIELD

The disclosure relates to a method of reducing a pathogenic microorganism population in a powdered nutritional food composition.

### BACKGROUND

Nutritional formulas today are well known for a variety of nutritional or disease specific applications in infants, children, and adults. These formulas most typically contain a balance of proteins, carbohydrates, lipids, vitamins, minerals, and other nutrients tailored to the nutritional needs of the intended user, and include product forms such as ready-to-drink liquids, reconstitutable powders, ready-to-feed liquids, dilutable liquid concentrates, nutritional bars, and others. The nutritional formulas may be performance enhancing or hypo-allergenic.

It may be desirable to increase the shelf life stability of these nutritional formulas, while maintaining a product that is safe to ingest. Towards these ends, heat and chemical based methods have been devised for inhibiting microbial growth or for reducing the level of pathogenic microorganisms in nutritional formulas. However, there remains a need for more efficient approaches for inactivating pathogenic microorganisms, inhibiting pathogenic microbial activity, or both, in nutritional formulas.

### BRIEF SUMMARY

Disclosed herein are methods of reducing a pathogenic microorganism population in a powdered nutritional food composition which includes a fat, a protein, and a carbohydrate. The method includes the steps of forming an emulsion of the powdered nutritional food composition and extruding the emulsified powdered nutritional food composition at a temperature of less than about 100° C. In some aspects, the methods also include the step of adding a probiotic. The methods produce at least a 5 log reduction of the pathogenic microorganism population in the extruded powdered nutritional food composition, the extruded powdered nutritional food composition having a water activity level of about 0.3 to about 0.95.

### DETAILED DESCRIPTION

It has now been discovered that the temperature at which extrusion of nutritional food compositions takes place has a direct impact on the extent to which pathogenic microbial populations are present in resultant products. For instance, extruding a nutritional composition at a temperature of below about 100° C. may decrease the presence of pathogenic microbial populations in the resulting extrudate. Nutritional food compositions and related methods for producing the nutritional food compositions with decreased pathogenic microbial populations are disclosed herein.

The elements or features of the various embodiments are described in detail hereinafter.

The terms “nutritional composition,” “nutritional product,” “nutritional food composition,” and “nutritional formula,” as used herein, refer to a nutritional formulation, which is designed for infants, children, or adults to contain sufficient protein, carbohydrate, fat, vitamins, minerals, and other nutrients to potentially serve as the sole source of nutrition when provided in sufficient quantity. The term “nutritional powder,” as used herein, unless otherwise specified, refers to nutritional products in flowable or scoopable form that can be reconstituted with water or another aqueous liquid prior to consumption and includes both spray dried and drymixed/dryblended powders. The term “nutritional liquid,” as used herein, unless otherwise specified, refers to nutritional products in ready-to-drink liquid form, concentrated form, and nutritional liquids made by reconstituting the nutritional powders described herein prior to use.

As used herein, “melting” means transition into a liquid state in which it is possible for one component to be homogeneously embedded in the other. Melting usually involves heating above the softening point of the material.

The term “downstream,” as used herein, refers to a direction in which the material is being conveyed in the extruder, i.e., the conveying direction.

The term “ready-to-feed,” as used herein, unless otherwise specified, refers to formulas in liquid form suitable for administration to an infant or adult, including reconstituted powders, diluted concentrates, and manufactured liquids.

The term “surrogate organism,” as used herein, unless otherwise specified, refers to a non-pathogenic organism that mimics the process resistance of a corresponding pathogenic organism and is suitable for use in validation work.

The term “kill ratio,” as used herein, unless otherwise specified, refers to a mathematical correlation between the destruction of a surrogate organism and the corresponding pathogenic organism.

The term “D-value,” as used herein, unless otherwise specified, refers to the time required at a constant temperature to destroy about 90% of the pathogenic microorganisms present. The D-value may be determined experimentally by conducting a study designed to determine the thermal resistance of a specific bacteria in a defined product. For instance, the D-value may equal (t2−t1)/log(N2/N1), where N1 is the number of surviving microorganisms at a first time t1 and N2 is the number of surviving microorganisms at a second time t2.

The term “Z-value,” as used herein, unless otherwise specified, refers to the change in temperature necessary to bring about a 1-log change in the D-value. The Z-value may be determined experimentally by conducting a study designed to determine the thermal resistance of a specific bacteria in a defined product.

The term “probiotic,” as used herein, unless otherwise specified, refers to a live microbe that, when administered in adequate amounts, confers a health benefit on the host. For example, a probiotic may counter the decimation of helpful intestinal bacteria by antibiotics to prevent antibiotic associated diarrhea.

The term “extruded powdered nutritional food composition” as used herein, unless otherwise specified, refers to the wet extrudate exiting the extruder.

As used herein, all concentrations expressed as either “mcg/liter” or “mg/liter” refer to ingredient concentrations within the infant formulas of the present invention as calculated on a ready-to-feed or as fed basis, unless otherwise specified.

As used herein, unless specified otherwise, “water activity level” is measured on the Aqua Lab model 4TE and the measurement is conducted at 22° C.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified. All numerical ranges as used herein, whether or not expressly preceded by the term “about,” are intended and understood to be preceded by that term, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

All documents (patents, patent applications and other publications) cited in this application are incorporated herein by reference in their entirety.

The formulas disclosed herein may also be substantially free of certain ingredients or features described herein, provided that the remaining formula still contains all of the required ingredients or features as described herein. In this context, the term “substantially free” means that the selected composition contains less than a functional amount of the optional ingredient, typically less than about 0.1% by weight, and also including zero percent by weight, of such optional or selected ingredient.

The formulas and corresponding methods may comprise, consist of, or consist essentially of the essential elements, steps, and limitations of the invention described herein, as well as any additional or optional ingredients, components, steps, or limitations described herein or otherwise useful in nutritional formula applications.

Compositions

Disclosed are nutritional food compositions including fat, protein, and carbohydrate wherein, in some embodiments, the composition includes one or more of vitamin, mineral, and/or other nutrients, all of which are selected in kind and amount to meet the dietary needs of the intended infant, child, or adult population. For instance, the nutritional composition may be a low acid pediatric or adult extruded product. The composition, when in the form of a wet extrudate, has a water activity level between about 0.3 and about 0.95, including, in some aspects, about 0.85 to about 0.92, including 0.91.

Many different sources and types of carbohydrates, fats, proteins, minerals, vitamins, and other nutrients are known and may be used in the nutritional formulas of the present invention, provided that such nutrients are compatible with the added ingredients in the selected formulation and are otherwise suitable for use in a formula.

Carbohydrate

In some embodiments, the carbohydrate component is present in a powdered infant formula in an amount of from about 30% to about 85%, including from about 30% to about 54%, including from about 30% to about 50%, and including from about 45% to about 60%, including from about 50% to about 55% by weight of the powdered infant formula. In other embodiments, the carbohydrate component is present in a powdered adult nutritional product in an amount of from about 5% to about 60%, including from about 7% to about 30%, including from about 10% to about 25%, by weight of the powdered adult nutritional product. In some embodiments, the carbohydrate component is present at these levels in combination with the protein and/or fat components at levels disclosed hereinafter.

The carbohydrate source may be any known or otherwise suitable source that is safe and effective for oral administration and is compatible with the essential and other ingredients in the selected product form.

Suitable carbohydrates include those carbohydrates which are simple, complex, lactose containing, lactose free, and combinations thereof. Some suitable carbohydrates or carbohydrate sources for use in the powdered nutritional products include glycerin, sucrose, dextrins, maltodextrin, tapioca maltodexrin, corn syrup, tapioca syrup, isomaltulose, lactose, fructose, both unhydrolyzed and partially hydrolyzed gums, gum Arabic (also known as gum acacia), xanthan gum, gum tragacanth, and guar gum, vegetable fibers, glucose, maltose, hydrolyzed, intact, naturally and/or chemically modified starch, cooked and uncooked waxy and non-waxy tapioca starch, cooked and uncooked waxy and non-waxy rice starch, uncooked waxy and non-waxy potato starch, tagatose, human milk oligosaccharides (HMOs), galacto-oligosaccharides (GOS), fructo-oligosaccharides (FOS), including short chain, moderate length chain, and long chain fructo-oligosaccharides, alpha-lactose, beta-lactose, polydextrose, and combinations thereof

Other suitable carbohydrates include any dietary fiber or fiber source, non-limiting examples of which include insoluble dietary fiber sources, such as oat hull fiber, pea hull fiber, soy hull fiber, soy cotyledon fiber, sugar beet fiber, cellulose, corn bran, yellow pea fiber, and combinations thereof

In one aspect, the carbohydrate for use in the nutritional formulation includes soluble and insoluble fibers, and other complex carbohydrates, for example having a DE (dextrose equivalent) value of less than about 40, including less than about 20, and also including from about 1 to about 10.

Fat

In some embodiments, the fat component is present in a powdered infant formula in an amount of from about 10% to about 50%, including from about 20% to about 50%, including from about 24% to about 50%, including from about 10% to about 35%, including from about 25% to about 30%, and including from about 26% to about 28% by weight of the powdered infant formula. Alternatively, in some embodiments, a minimum amount of fat is included. In those embodiments, fat is present in a powdered nutritional food composition such that it constitutes at least about 20%, including at least about 30%, including at least about 40% of the powdered nutritional food composition. In other embodiments, the fat component is present in an a powdered adult nutritional product, in an amount of from about 0.5% to about 30%, including from about 1% to about 10%, and also including from about 2% to about 5% by weight of the powdered adult nutritional product. In some embodiments, the fat component is present at these levels in combination with the protein and/or carbohydrate components at levels disclosed herein.

The fat may be any known or otherwise suitable source that is safe and effective for oral administration and is compatible with the essential and other ingredients in the selected product form.

Suitable fat or fat sources include coconut oil, soy oil, high oleic safflower or sunflower oil, safflower oil, sunflower oil, corn oil, palm oil, palm kernel oil, canola oil, triheptanoin, milk fat including butter, any animal fat or fraction thereof, fish or crustacean oils containing docosahexaenoic acid (DHA) and/or eicosapentaenoic acid (EPA), phospholipids from fish or crustaceans containing docosahexaenoic acid (DHA) and/or eicosapentaenoic acid (EPA), concentrates of DHA and/or EPA from marine, vegetable, or fungal sources, arachidonic acid (AA) concentrate from fungal or other sources, alpha-linolenic acid concentrate (ALA), flax seed oil, phospholipids and fractions thereof, lecithins (e.g., soy, egg, canola, sunflower), both partially hydrolyzed and unhydrolyzed, monoglycerides and/or diglycerides from both vegetable and animal sources, and plant sterols and compounds containing plant sterols, diacetyl tartaric acid of mono and diglycerides (DATEM), and combinations thereof

Protein

In some embodiments, the protein component is present in a powdered infant formula in an amount of from about 5% to about 35%, including from about 10% to about 18%, including from about 10% to about 15%, also including from about 8% to about 12%, including from about 10% to about 12% by weight of the powdered infant formula. In other embodiments, the protein component is present in a powdered adult nutritional product in an amount of from about 10% to about 90%, including from about 30% to about 80%, and also including from about 40% to about 75% by weight of the powdered adult nutritional product. The protein may be any known or otherwise suitable source that is safe and effective for oral administration and is compatible with the essential and other ingredients in the selected product form. In some embodiments, the protein component is present at these levels in combination with the fat and/or carbohydrate components at levels disclosed herein. For example, in an embodiment, the powdered nutritional food composition includes about 10% to about 15% protein, from about 30% to about 50% carbohydrate, and about 20% to about 50% fat.

In some embodiments, the extruded powdered nutritional food composition is reconstituted into liquid form. As such, the amount of protein, carbohydrate, and fat is provided as a concentration based on the volume of liquid nutritional composition. In an embodiment, the reconstituted powdered nutritional food composition includes from about 54 to about 108 gm/L of carbohydrate, from about 20 to about 54 gm/L of fat, and from about 7 to about 24 gm/L of protein.

Suitable protein or protein sources include either intact, partially hydrolyzed, or fully hydrolyzed, or a combination thereof, of lactase treated nonfat dry milk, milk protein isolate, milk protein concentrate, whey protein concentrate, glycomacropeptides, whey protein isolate, milk caseinates such as sodium caseinate, calcium caseinate, or any combination of caseinate salts of any mineral, soy protein concentrate, soy protein isolate, soy protein flour, pea protein isolate, pea protein concentrate, any monocot or dicot protein isolate or protein concentrate, animal collagen, gelatin, all amino acids, taurine, methionine, milk protein peptides, whey protein peptides, bovine colostrum, human colostrum, other mammalian colostrum, genetic communication proteins found in colostrum and in mammalian milk such as, but not limited to interleukin proteins, hydrolyzed animal collagen, hydrolyzed yeast, and combinations thereof

Macronutrient Profile

The total amount or concentration of fat, carbohydrate, and protein, in the powdered nutritional products of the present disclosure can vary considerably depending upon the selected formulation and dietary or medical needs of the intended user. Additional suitable examples of macronutrient concentrations are set forth below. In this context, the total amount or concentration refers to all fat, carbohydrate, and protein sources in the powdered product. For powdered infant formulas, such total amounts or concentrations are most typically formulated within any of the embodied ranges described in the following table (all numbers have “about” in front of them).

TABLE 1

| | Embodiment A | Embodiment B | Embodiment C |
|---|---|---|---|
| Nutrient | (% Calories) | (% Calories) | (% Calories) |
| Carbohydrate | 20-85 | 30-60 | 35-55 |
| Fat | 5-70 | 20-60 | 25-50 |
| Protein | 2-75 | 5-50 | 7-40 |

For powdered adult nutritional products, such total amounts or concentrations are most typically formulated within any of the embodied ranges described in the following table (all numbers have “about” in front of them).

TABLE 2

| | Embodiment D | Embodiment E | Embodiment F |
|---|---|---|---|
| Nutrient | (% Calories) | (% Calories) | (% Calories) |
| Carbohydrate | 1-98 | 10-75 | 30-50 |
| Fat | 1-98 | 20-85 | 35-55 |
| Protein | 1-98 | 5-70 | 15-35 |

In some embodiments, the powdered nutritional products of the present disclosure include other components that may modify the physical, chemical, aesthetic or processing characteristics of the products or serve as pharmaceutical or additional nutritional components when used in the targeted population. Many such ingredients are known or otherwise suitable for use in medical food or other nutritional products or pharmaceutical dosage forms and may also be used in the formulations herein, provided that such optional ingredients are safe and effective for oral administration and are compatible with the essential and other ingredients in the selected product form.

Non-limiting examples of such ingredients include preservatives, anti-oxidants, emulsifying agents, buffers, pharmaceutical actives, additional nutrients as described herein, vitamins, minerals, sweeteners including artificial sweeteners (e.g., saccharine, aspartame, acesulfame, Stevia extract, and sucralose) colorants, flavorants in addition to those described herein, thickening agents and stabilizers, emulsifying agents, lubricants, probiotics (such as acidophilous and/or bifidus bacteria, both alive and inactive), prebiotics, beta-hydroxy beta-methylbutyrate (11 MB), arginine, glutamine, and so forth.

Non-limiting examples of suitable minerals for use herein include phosphorus, sodium, chloride, magnesium, manganese, iron, copper, zinc, iodine, calcium, potassium, chromium, molybdenum, selenium, and combinations thereof.

Non-limiting examples of suitable vitamins for use herein include carotenoids (e.g., beta-carotene, zeaxanthan, lutein, lycopene), biotin. choline, inositol, folic acid, pantothenic acid, choline, vitamin A. thiamine (vitamin B), riboflavin (vitamin B2), niacin (vitamin B3), pyridoxine (vitamin B6), cyanocobalamine (vitamin B12), ascorbic acid (vitamin C), vitamin D. vitamin E, vitamin K, and various salts, esters or other derivatives thereof, and combinations thereof

For powder embodiments, such powders are typically in the form of flowable or substantially flowable particulate compositions, or at least particulate compositions that may be easily scooped and measured with a spoon or similar other device, wherein the compositions can easily be reconstituted by the intended user with a suitable aqueous fluid, typically water, to form a liquid nutritional formula for immediate oral or enteral use. In this context, “immediate” use generally means within about 48 hours, most typically within about 24 hours, preferably right after reconstitution. These powder embodiments may typically be made by the extrusion process defined hereinafter. The quantity of a nutritional powder required to produce a volume suitable for one serving can vary.

The formulas may be packaged and sealed in single or multi-use containers, and then stored under ambient conditions for up to about 36 months or longer, more typically from about 12 to about 24 months. For multi-use containers, these packages can be opened and then covered for repeated use by the ultimate user, provided that the covered package is then stored under ambient conditions and the contents are used within about one month or so.

Methods

Disclosed herein are methods for reducing a pathogenic microorganism population in a powdered nutritional food composition which includes a fat, a protein, and a carbohydrate.

The method includes the steps of forming an emulsion of the powdered nutritional food composition and extruding the emulsified powdered nutritional food composition at a temperature of less than about 100° C. This results in at least about a 5 log reduction in the pathogenic microorganism population in the extruded powdered nutritional food composition. The extruded powdered nutritional food composition has a water activity level of about 0.3 to about 0.95.

In one aspect, the emulsion is formed within the extruder.

In one aspect, the powdered nutritional food composition includes at least about 20% fat.

In one aspect, the pathogenic microorganism population includes microorganisms selected from the group consisting of Listeria monocytogenes, E. coli, Salmonella Enteritidis, Cronobacter sakazakii, and Enterbacteriacea, and combinations thereof

In one aspect, the pathogenic microorganism population includes Listeria monocytogenes.

In some aspects, the pathogenic microorganism population undergoes a reduction of at least about 5.5 log, or at least about 5.7 log, or at least about a 5.77 log.

In one aspect, the pathogenic microorganism population has a Z-value of greater than about 10° F., including greater than about 15° F.

In one aspect, the method occurs over a temperature range of about 20° C.

In one aspect, the method occurs at a substantially constant temperature, of less than about 95° C., less than about 90° C., or less than about 85° C.

In one aspect, a probiotic is added to an emulsified powdered nutritional food composition.

In one aspect, the emulsified powdered nutritional food composition is extruded with a residence time of about 1½ to about 10 minutes, including about 2½ to about 10 minutes and about 2½ to about 3 minutes.

In one aspect, the emulsified powdered nutritional food composition is extruded at a pressure of about 10 psig to about 1500 psig, including up to a maximum pressure of about 1500 psig, including a pressure of about 750 psig.

In one aspect, the powdered nutritional food composition includes at least one of vitamins, minerals, and other nutrients.

In one aspect, the powdered nutritional food composition includes from about 10% to about 15% protein, from about 30% to about 50% carbohydrate, and from about 20% to about 50% fat.

In one aspect, the extruded powdered nutritional food composition, when reconstituted in liquid form, includes from about 54 to about 108 gm/L of carbohydrate, from about 20 to about 54 gm/L of fat, and from about 7 to about 24 gm/L of protein.

In one aspect, the extruded powdered nutritional food composition is dried to a moisture content of less than about 5%.

In one aspect, following drying, the dried powdered nutritional food composition is milled and reconstituted to a ready-to-feed state.

In one aspect where probiotics are added to the emulsified powdered nutritional food composition, at least about 80% of the added probiotic is retained in the extruded powdered nutritional food composition.

Extruders are known in the art (see, for example, U.S. Provisional Patent Application 61/393,206, published as International Published Patent Application WO 2012/049253, entitled “Curcuminoid Solid Dispersion Formulation,” published Apr. 19, 2012). In one aspect, an extruder that includes a housing or barrel divided into several sections in a longitudinal direction is used. For example, the extruder is divided into twelve barrel sections. Alternatively, the extruder includes 14 barrel sections, or any other suitable number of barrels that will be apparent to one with ordinary skill in the art in view of the teachings herein. The extrusion step may be performed across the barrel sections of the extruder such that the barrel sections include multiple powder and/or liquid feeds. On the upstream side of the extruder, an opening may be provided for feeding the components described above. The opening may be provided in the first barrel section. The barrel sections may be ordered relative to the direction of conveyance within the extruder. A hopper may be placed on this opening so that the powder can easily be fed into the barrel of the extruder. For example, the protein and/or carbohydrate blends may be introduced via the hopper.

After the powder blends are fed into the extruder, water may be added to the extruder to perform hydration. The water fed into the extruder may be potable. Optionally, the water may be distilled. For example, water may be fed into a barrel section downstream of the powder feed barrel section, such as the second barrel section of the extruder. Hydration may then be performed on the mixture. For example, hydration may be performed between the second barrel section and the fifth barrel section. Hydration may be performed at a temperature of about 80° C. and at a moisture content of about 24.4% to about 37.5%. The water activity level is between about 0.3 and 0.95, including about 0.85 to about 0.92, including about 0.91.

After the composition has been hydrated, an oil blend may be introduced into the extruder. Once the oil blend is introduced, the composition within the extruder may be emulsified (i.e., the composition is emulsified within the extruder). For example, the oil blend may be introduced into the fifth barrel section of the extruder. Emulsification may then be performed between the fifth barrel section and the eighth barrel section. Emulsification may be performed at a temperature of about 80° C. and at a moisture content of about 24.4% to about 37.5%. The water activity level is between about 0.3 and 0.95, including about 0.85 to about 0.92, including about 0.91. Emulsification may also be performed outside of the extruder.

A lactose blend and galactooligosaccharides (GOS) may be introduced into the extruder in the eighth barrel section. Optionally, the lactose blend may be introduced into the extruder in the first or fifth barrel section, or the lactose blend may be divided between the first, fifth and/or eighth barrel sections. The GOS may be introduced into the eighth barrel section such that dispersive mixing is performed from the eighth barrel section to the twelfth, or final, barrel section. Dispersive mixing may be performed at a temperature of about 60° C. and at a moisture content of about 7.5% to about 13.2%. The water activity level is between about 0.3 and 0.95, including about 0.85 to about 0.92, including about 0.91.

The extruder may include at least one rotating shaft. Alternatively, it may include two or up to twelve rotating shafts, or any other suitable number of shafts. The extruder may be a twin-screw extruder. The shafts may be co-rotating or counter-rotating. Processing elements disposed on adjacent shafts may closely intermesh. The rotating shaft(s) may rotate at a speed of about 500 rpm.

Each shaft may carry a plurality of processing elements disposed axially one behind the other. The processing elements define a feeding and conveying section, at least one mixing section, and a discharging section. The feeding and conveying section is positioned farthest upstream, close to the hopper of the extruder, the at least one mixing section is positioned downstream of the feeding and conveying section, and the discharging section is positioned farthest downstream, close to the discharge opening of the extruder.

The processing elements of the feeding and conveying section as well as the discharging section may be formed by screw-type elements. These screw-type elements may form an endless screw having the feed direction and a uniform pitch flight. Thus, in the feeding and conveying section the powder is fed into the extruder and conveyed in the downstream direction, for example at a feed rate of about 0.5 to about 1.5 kg/h, or about 0.5 to about 1.0 kg/h. However, the feed rate, flow rate, and entry points to the different barrel sections are dependent on the size of the extruder. Other suitable feed rates, flow rates, and entry points will be apparent to one with ordinary skill in the art based on the teachings herein.

In the mixing section(s), the material to be processed may be homogenized by mixing or kneading. Suitably, paddle means or kneading blocks may be used. These kneading blocks consist of cam disks mutually offset at an angle in a peripheral direction. The cam disks have abutting faces that are perpendicular to the general conveying direction in the extruder. Alternatively, the mixing section(s) are defined by processing element(s) that may include a mixing element that may be derived from a screw type element. A mixing element “being derived from a screw type element” is intended to mean an element whose basic shape is that of a screw element, but which has been modified such that it exerts a compounding or mixing effect in addition to a conveying effect. Further, the extruder may include one or more than one, for example three or four, mixing sections, which are connected by intermediate conveying sections formed by screw-type elements.

The extruder shaft may include one or more than one reverse-flight section(s), for example arranged after the (last) mixing section and defined by reverse-flight elements. A reverse-flight element has a screw with a reverse-flight relative to the screw-type elements which may be arranged in the feeding and conveying section which define the general conveying direction of the extruder. Thus, the reverse-flight element conveys the material in an opposite direction relative to the general conveying direction of the extruder and serves to create sufficient back-pressure to allow for a desired degree of mixing and/or homogenization. The reverse-flight element is designed to stow the material conveyed in the extruder. Therefore, it may also be called a back-pressure element.

The substances which are fed to the extruder may be melted in order to homogenize the melt and to disperse or dissolve the components efficiently.

The extruder housing may be heated in order to form a melt from the substances fed into the extruder. It will be appreciated that the working temperatures will also be determined by the kind of extruder or the kind of configuration within the extruder that is used. A part of the energy needed to melt, mix, and dissolve the components in the extruder can be provided by heating elements, while the friction and shearing of the material in the extruder can also provide the mixture with a substantial amount of energy and aid in the formation of a homogenous melt of the components. In order to obtain a homogenous distribution and a sufficient degree of dispersion of the ingredients, the melt may be kept in the heated barrel of the melt extruder for a sufficient length of time.

According to one aspect of the process, the barrel of the extruder is divided into several heating zones. The temperature in these heating zones can be controlled in order to control the melting of the dispersion. For example, a portion of the barrel sections are heated to about 80° C. to about 90° C., and the final barrel section is heated to about 60° C., whereby the method occurs over a temperature range of about 20° C. A residence time within the extruder may range from between about 1½ minutes to about 10 minutes, including from about 2.5 minutes to about 10 minutes, for the extrusion step.

After the extrusion step, the extruded powdered nutritional food composition may be dried using a vacuum belt dryer. For example, a Merk Vacuum belt dryer may be used. The amount of drying time depends on the amount of water added during hydration. For example, about 1.0 to about 1.6 kg/hr of water may require about 15 to about 30 minutes, or about 25 minutes, of drying time. The vacuum pressure may be about 20 to about 50 mbar, or about 30 mbar. The vacuum drying temperature may be about 120° C. to about 135° C. The dried extrudate product may contain less than or equal to about 5% moisture content, such as about 2% to about 5%.

Alternatively, the extruded powdered nutritional food composition may be dried using a microwave dryer. After the composition has been extruded, the composition may be subjected to radiation via a microwave dryer. For instance, the wet extruded powdered nutritional food composition may be dried in the microwave dryer for a period of about 5 to about 20 minutes. The microwave dryer may have a vacuum pressure of about 20 mbar to about 30 mbar and a power of about 0.3 to about 1.0 KW. The dried powdered nutritional food composition may contain less than or equal to about 5% moisture content, such as about 2% to about 5%.

Alternatively, the extruded powdered nutritional food composition may be dried using a drum dryer. A drum dryer may include a pair of drums rotating in opposing directions. The drums may be heated, such as with steam or thermal oil, to dry the wet extruded powdered nutritional food composition applied to the drums. For instance, the drums may rotate between about 0.5 to about 3 rpm, such as about 2 rpm. The wet extruded powdered nutritional food composition may be dried in the drum dryer for a period of about 15 to about 90 seconds at a temperature of about 90° C. to about 140° C. The rotary drum dryer may have a vacuum pressure of about 50 mbar. The dried powdered nutritional food composition may contain less than or equal to about 5% moisture content, such as about 2% to about 5%.

Once dried, the dried powdered nutritional food composition may be milled to obtain the desired particle size. The milling settings may influence the particle size of the milled powdered nutritional food composition, which may affect the dissolution of the milled powdered nutritional food composition. In some embodiments, the milled powdered nutritional food composition is also reconstituted to a ready-to-feed state. The dried powdered nutritional food composition may be milled such that about 85% to about 95% of the particles are within about 267 to about 751 microns. Milling may include grinding a solid dispersion product that exits the extruder or vacuum belt dryer to granules. The granules may then be compacted. Compacting means a process whereby a powder mass comprising granules is condensed under high pressure to obtain a mass with low porosity, e.g., a tablet. Compression of the powder mass is usually done in a tablet press, more specifically in a steel die between two moving punches. The nutritional powder may comprise a moisture content of about 2.2% and a water activity level of about 0.46.

Microbial Reduction

The pathogenic microorganism population of the nutritional composition is reduced through the extrusion process described above. In some embodiments, target pathogenic microorganism populations that are reduced using the above-described methods include Cronobacter sakazakii, Salmonella Enteritidis, E. coli, Enterobacteriaceae, and/or Listeria monocytogenes. Table 3 lists the measured D-values for the pathogenic microorganisms based on the following temperatures.

TABLE 3

| | Measured D-value (min.) | | | | |
|---|---|---|---|---|---|
| Temp | Cronobacter | Salmonella | E. | Entero- | Listeria |
| ° F. | sakazakii | Enteritidis | coli | bacteriaceae | monocytogenes |
| 145 | 18.1 | 12.6 | 26.4 | 20.3 | 10.1 |
| 150 | 6.8 | 5.6 | 14.4 | 11.7 | 5.3 |
| 155 | 3.3 | 2.7 | 5.5 | 7.1 | 2.6 |
| 160 | 1.2 | 1.2 | 1.9 | 1.7 | 1.5 |
| 165 | 0.4 | 0.71 | 1.0 | 1.1 | 0.63 |

Based on the D-values in Table 3, the Z-values for each pathogenic microorganism were determined. Table 4 lists the Z-values for the pathogenic microorganisms.

TABLE 4

| Microorganism | Z-value (° F.) |
|---|---|
| Cronobacter sakazakii | 12.3 |
| Salmonella Enteritidis | 15.8 |
| E. coli | 13.4 |
| Enterobacteriaceae | 14.9 |
| Listeria monocytogenes | 16.8 |

Because Listeria had the highest Z-value, Listeria was considered to be the most heat resistant of the selected microorganisms. Pediococcus acidilactici, in particular, Pediococcus acidilactici DSM20284, is a probiotic that has similar properties to that of Listeria and may be used as a surrogate for Listeria to verify methods, thereby avoiding the use of infectious agents. The measured D-values for Pediococcus are listed below in Table 5. Based on the D-values, the Z-value for Pediococcus was determined to be 14.7° F. Based on the corresponding D-values and Z-values, the kill ratio of Listeria to Pediococcus is expected be about 1.5 at about 194° F. That is, in the time it takes to produce about a 7 log reduction in Pediococcus at a temperature of about 194° F., about a 4.6 log reduction in Listeria is expected at about the same temperature. The kill ratio of Listeria to Pediococcus is expected to be about 1.2 at 180° F. That is, in the time it takes to produce about a 7 log reduction in Pediococcus at a temperature of about 180° F., about a 5.8 log reduction in Listeria is expected at about the same temperature. Streptococcus thermophilus may also be used as a surrogate for Listeria, it may be used alone, or in combination with a probiotic (e.g. BB12).

TABLE 5

| Temp (° F.) | Measured D-value (min.) of Pediococcus |
|---|---|
| 145 | 16.2 |
| 150 | 7.1 |
| 155 | 2.9 |
| 160 | 1.6 |
| 165 | 0.67 |

Pediococcus may be added to the ingredients of the nutritional compositions described above to determine the microbial reduction for Listeria during the extrusion process. For instance, Pediococcus may be added to the lactose blend, such that the nutritional composition includes about 6.1% GOS, about 23.7% oil, about 13.2% water, about 21.9% protein blend, and about 35.1% lactose blend. The lactose blend may be introduced into one or more of barrels 1, 5, and 8 of the extruder. Because the lactose blend contains the surrogate organism, introducing the lactose blend in barrel 8 may result in the least amount of microbial reduction because of the shorter residence time within the extruder.

The nutritional composition comprising the surrogate microorganism may be extruded. The water feed rate may be about 1.0 kg/h, about 1.3 kg/h, or about 1.5 kg/h. The extruder may be held at a constant temperature, such that the method occurs at a temperature of about 82° C. or about 90° C. or about 95° C. Table 6 lists the measured microbial reductions for nutritional compositions extruded at the above-listed water feed rates and the process temperatures of 82° C. and 90° C.

TABLE 6

| | Water | | | | |
|---|---|---|---|---|---|
| | Feed | Process | Pediococcus | | |
| | Rate | Temp | log | Kill | Listeria log |
| Process | (kg/h) | (° C.) | reduction | ratio | reduction |
| 1 | 1.5 | 82 | >7.19 | 1.2 | >5.99 |
| 2 | 1.5 | 90 | >7.19 | 1.5 | >4.79 |
| 3 | 1.3 | 90 | >7.19 | 1.5 | >4.79 |
| 4 | 1.0 | 90 | >7.19 | 1.5 | >4.79 |
| 5 | 1.5 | 82 | >6.93 | 1.2 | >5.77 |
| 6 | 1.5 | 90 | >6.93 | 1.5 | >4.62 |

In processes 1-4, the lactose blend comprising the surrogate organism was introduced into barrel 1. In processes 5-6, the lactose blend comprising the surrogate organism was introduced into barrel 8. The resulting log reduction in Pediococcus was greater than about 6.93 to greater than about 7.19. The log reduction for Listeria may be determined using the kill ratio between Listeria and Pediococcus at the corresponding process temperature. Accordingly, the resulting log reduction in Listeria was greater than about 4.62 to greater than about 5.99. Under the worst case conditions, a process temperature of about 82° C. and introducing the microorganism into barrel 8 of the extruder, a greater than about 5.77 log reduction of Listeria was found based upon the kill ratio between Listeria and the surrogate organism at the corresponding process temperature. Because Listeria was determined to be the most heat resistant, other pathogenic microorganisms with lower Z-values (e.g., Cronobacter sakazakii, Salmonella Enteritidis, E. coli, Enterobacteriaceae, etc.) are expected to experience a greater log reduction through the extrusion process.

In some aspects, it is desirable to add a probiotic to the emulsified powdered nutritional food composition. Added probiotics can confer one or more health benefits to the user, such as to counter the decimation of helpful intestinal bacterial and prevent antibiotic associated diarrhea. Suitable probiotics include Bifidobacterium lactis HNO19, Lactobacillus reuteri ATCC55730, Lactobacillus rhamnosus GG (LGG), Lactobacillus casei DN-114 001, Bifidobacterium lactis Bb-12, etc. The probiotic may be added to the extruder after the pathogens have been reduced by the desired log reduction. For instance, the probiotic may be added and mixed with the composition in the final barrel section, after cooling of the composition. Alternatively, the probiotic may be added in the extruder with the lactose blend in barrel 8 such that the probiotic is dispersively mixed with the composition. In some aspects, at least about 70% or at least about 80%, or at least about 90% of the probiotic survives when the nutritional composition exits the extruder. Thus, in an embodiment, a method of reducing a pathogenic microorganism population in a powdered nutritional food composition including a fat, a protein, and a carbohydrate is provided. In the embodiment, the method includes the steps of forming an emulsion of the powdered nutritional food composition, adding a probiotic to the emulsified powdered nutritional food composition to produce a mixed powdered nutritional food composition, and extruding the mixed powdered nutritional food composition at a temperature of less than about 100° C. In the embodiment, the extruded powdered nutritional food composition maintains at least about 80% of the added probiotic and sustains at least about a 5 log reduction in the pathogenic microorganism population. The extruded powdered nutritional food composition has a water activity level of about 0.3 to about 0.95.

The following example is intended to be illustrative and not limiting of the present invention. The methods may be carried out using other known or otherwise suitable techniques not specifically described herein without departing from the spirit and scope of the present disclosure. The present embodiments are, therefore, to be considered in all respects as illustrative and not restrictive and that all changes and equivalents also come within the description of the present disclosure. The following non-limiting example further illustrates the compositions and methods of the present disclosure.

### Example

The following is an example of the production of a powdered nutritional food composition as disclosed herein. As shown in Table 7, and described in further detail below, the powdered nutritional food composition is produced by adding the identified ingredients (Ingredient Description), in the identified concentrations (Amount), to the extruder at the identified points within the extruder (Point of addition).

TABLE 7

| | Point of addition in | Amount, |
|---|---|---|
| Ingredient Description | Extruder | kg/1,000 kg |
| NFDM | Protein Blend | 199 |
| WPC | Barrel 1 | 60.3 |
| Water | Barrel 2 | 101-162 |
| HOSO (High Oleic Saflower | Oil Blend | 112 |
| Oil) | Barrel 5 | |
| Soy Oil | | 83.5 |
| Coconut Oil | | 76.9 |
| ARA | | 2.87 |
| Lecithin Ultralec | | 1.10 |
| DHA | | 1.08 |
| Vitamin ADEK | | 0.368 |
| MC Premix | | 0.182 |
| Beta Carotene | | 0.000598 |
| GOS | Barrel 8 | 65.5 |
| Lactose | Lactose Blend | 376 |
| Potassium Citrate | Barrel 8 | 8.05 |
| Calcium Carbonate | | 4.18 |
| Nucleotide/Choline Premix | | 2.29 |
| Potassium Chloride | | 1.52 |
| Sodium Ascorbate | | 1.44 |
| Vitamin/Mineral Premix | | 1.09 |
| Magnesium Chloride | | 0.874 |
| Sodium Chloride | | 0.781 |
| Ferrous Sulfate | | 0.442 |
| Choline Chloride | | 0.421 |
| L-Carnitine | | 0.0256 |
| Riboflavin | | 0.00310 |

The ingredients listed above are extruded to form an extruded powdered nutritional food composition. The protein blend is introduced into barrel 1 of the extruder via a hopper. Water is then be added into barrel 2 to perform hydration between the second barrel section and the fifth barrel section. After the composition has been hydrated, the oil blend is introduced into barrel 5 of the extruder. Once the oil blend is introduced, the composition within the extruder is emulsified (i.e., the composition is emulsified within the extruder) between the fifth barrel section and the eighth barrel section. After emulsification, galactooligosaccharides (GOS) and the lactose blend are introduced into barrel 8 of the extruder, wherein dispersive mixing is performed between the eighth barrel section to the twelfth, or final, barrel section. Pediococcus acidilactici is added with the lactose blend to achieve at least a 5 log reduction in the microorganism.

The extruder is heated to 82° C. and the process is carried out at a maximum pressure of 750 psig. The residence time of the nutritional composition within the extruder is between about 2½ to about 3 minutes. The ingredients include a water activity level of about 0.91. The lactose blend shown in the table above includes the microorganism Pediococcus acidilactici. Following the extrusion step, a greater than about a 6.93 log reduction in Pediococcus is obtained. With a 1.2 kill ratio, this corresponds to a greater than about a 5.77 log reduction in Listeria monocytogenes.

After the extrusion step, the extruded powdered nutritional food composition is dried in a Merk Vacuum belt dryer according to the parameters in the following table.

TABLE 8

| | | | | | | | Residence | |
|---|---|---|---|---|---|---|---|---|
| Zone temp, ° C. | | | | IR, ° C. | | Cooling | time | Vacuum |
| 1 | 2 | 3 | 4 | 1&2 | 3&4 | 5&6 | (min.) | (mbar) |
| 135 | 125 | 120 | 110 | 145 | 130 | 30 | 25 | 30 |

The dried powdered nutritional food composition contains less than about a 5% moisture content. Once dried, the dried powdered nutritional food composition is milled using a Fitzmill to obtain granules in the range of from about 275 to about 325 microns. The milled powdered nutritional food composition is then reconstituted to a ready-to-feed state.

1. A method of reducing a pathogenic microorganism population in a powdered nutritional food composition comprising a fat, a protein, and a carbohydrate, the method comprising the steps of:
a) forming an emulsion of the powdered nutritional food composition; and
b) extruding the emulsified powdered nutritional food composition in an extruder at a temperature of less than about 100° C., whereby there is at least about a 5 log reduction in the pathogenic microorganism population in the extruded powdered nutritional food composition, and wherein the extruded powdered nutritional food composition has a water activity level of about 0.3 to about 0.95.

2. The method of claim 1, wherein the emulsion is formed within the extruder.

3. The method of claim 1, wherein the powdered nutritional food composition comprises at least about 20% fat.

4. The method of claim 1, wherein the pathogenic microorganism population comprises microorganisms selected from the group consisting of Listeria monocytogenes, E. coli, Salmonella Enteritidis, Cronobacter sakazakii, Enterbacteriacea, and combinations thereof.

5. The method of claim 4, wherein the pathogenic microorganism population comprises Listeria monocytogenes.

6. The method of claim 5, wherein there is at least about a 5.5 log reduction in the pathogenic microorganism population.

7. The method of claim 6, wherein there is at least about a 5.7 log reduction in the pathogenic microorganism population.

8. The method of claim 1, wherein the Z-value for the pathogenic microorganism population is greater than about 10° F.

9. The method of claim 8, wherein the Z-value for the pathogenic microorganism population is greater than about 15° F.

10. The method of claim 1, wherein the method occurs over a temperature range of about 20° C.

11. The method of claim 1, wherein the method occurs at a temperature of less than about 95° C.

12. The method of claim 11, wherein the method occurs at a temperature of less than about 90° C.

13. The method of claim 1, further comprising adding a probiotic to the emulsified powdered nutritional food composition.

14. The method of claim 1, wherein the powdered nutritional food composition is in the extruder for a residence time of about 2.5 to about 10 minutes.

15. The method of claim 1, wherein the emulsified powdered nutritional food composition is extruded at a maximum pressure of about 1500 psig.

16. The method of claim 1, wherein the powdered nutritional food composition further comprises at least one of vitamins, minerals, and other nutrients.

17. The method of claim 1, wherein the powdered nutritional food composition comprises from about 10% to about 15% protein, from about 30% to about 50% carbohydrate, and from about 20% to about 50% fat.

18. The method of claim 1, wherein the extruded powdered nutritional food composition, when reconstituted in liquid form, comprises from about 54 to about 108 g/L of carbohydrate, from about 20 to about 54 g/L of fat, and from about 7 to about 24 g/L of protein.

19. The method of claim 1, further comprising the step of drying the extruded powdered nutritional food composition to a moisture content of less than about 5%.

20. The method of claim 19, further comprising the steps of milling the dried powdered nutritional food composition and reconstituting the milled powdered nutritional food composition to a ready-to-feed state.

21. A method of reducing a pathogenic microorganism population in a powdered nutritional food composition comprising a fat, a protein, and a carbohydrate, the method comprising the steps of:
a) forming an emulsion of the powdered nutritional food composition;
b) adding a probiotic to the emulsified powdered nutritional food composition to form a mixed powdered nutritional food composition; and
c) extruding the mixed powdered nutritional food composition at a temperature of less than about 100° C., whereby at least about 80% of the added probiotic is retained in the extruded powdered nutritional food composition, and whereby there is at least about a 5 log reduction in the pathogenic microorganism population in the extruded powdered nutritional food composition, wherein the extruded powdered nutritional food composition has a water activity level of about 0.3 to about 0.95.
